(19) United States
(12) Patent Application Publication
(10) Pub. No.: US 2010/0178182 A1
(43) Pub. Date: Jul. 15, 2010

(54) HELICAL BELLOWS, PUMP INCLUDING SAME AND METHOD OF BELLOWS FABRICATION

(76) Inventors: Tom M. Simmons, Kamas, UT (US); John M. Simmons, Marion, UT (US); David M. Simmons, Francis, UT (US)

Correspondence Address: TRASKBRITT, P.C., P.O. BOX 2550, SALT LAKE CITY, UT, 84110, US

(21) Appl. No.: 12/351,516

(22) Filed: Jan. 9, 2009

(51) Int. Cl. F04B 45/02; B23P 15/00

(52) U.S. Cl. 417/472; 29/888.02

(57) ABSTRACT

A helical pump system includes at least one pressure chamber at least partially defined by a helical bellows plunger comprised of a tubular body, a closed front portion, an open rear portion, and at least one contour extending continuously as a helix, longitudinally from proximate the front portion to proximate the rear portion. Methods for forming a helical bellows plunger include molding the helical bellows plunger using a mold core comprising a helically extending exterior contour and a cooperatively associated mold cavity comprising a helically extending interior contour of substantially a same pitch and configured to align with the helically extending exterior contour of the mold core, introducing a molding material therebetween, curing the molding material, and unscrewing the cured molding material from the mold core.

### TECHNICAL FIELD

The present invention relates generally to positive displacement devices. More particularly, embodiments of the present invention relate to bellows for use in a reciprocating device, reciprocating pumps including such bellows and methods of forming bellows.

### BACKGROUND

Numerous industries and many applications utilize reciprocating pumps for transporting fluids. For example, reciprocating pumps are found in industries such as shipping, processing, manufacturing, irrigation, gasoline supply, air conditioning systems, flood control, marine services, etc. Conventional reciprocating fluid pumps may be constructed with one or more fluid chambers including an associated pumping structure comprising a member for displacing fluid, such as a bellows plunger or a diaphragm.

The pumping member may be driven such that when one fluid chamber is being compressed to expel fluid, another fluid chamber is expanded to receive fluid. The pumping structure may similarly include a plurality of pressure chambers, which alternate being filled with pressurized air and exhausting air. A valve, such as a spool valve or electronic controllers, may be used to operate and control the pumping member, shifting the pressurized air flow from one pressure chamber to the other as the pumping member reaches the end of a pumping stroke. A valve spool element in the spool valve may be shifted between two positions. One valve spool element position may supply pressurized air to the pressure chamber of one side of the pump while simultaneously exhausting the air from the pressure chamber on the other side of the pump, while the other position reverses the pressurization and exhaust cycle. Thus, the shifting of the valve spool element simply alternates this pressurized air/exhaust between pressure chambers, driving the pumping member in a reciprocating pumping action.

The most widely used pumping member is the diaphragm, due to its simplicity and relatively low manufacturing cost. As a conventional diaphragm is driven in a reciprocating pumping action, the diaphragm material is typically forced to flex and bend, and at times fold on itself. Such bending and folding causes stress cracks in the diaphragm material. Over time, these cracks grow and become deeper until the diaphragm ultimately fails. A bellows plunger design conventionally outperforms other designs, such as the diaphragm design, since the diaphragm design is far more susceptible to operational stress-induced failure. However, conventional bellows plungers are somewhat difficult and, thus, expensive to manufacture and exhibit quality control problems.

### BRIEF SUMMARY

Various embodiments of the present invention comprise a pump bellows, which may also be characterized as a bellows plunger. In one or more embodiments, the pump bellows may comprise a generally tubular body. An end cap, which may also be characterized as an end plate may be coupled to the generally tubular body at one longitudinal end thereof. At an opposing longitudinal end of the generally tubular body there may be an opening. The generally tubular body may further comprise at least one continuous, helical contour comprising at least one helical groove forming ribs of the bellows and extending from proximate one longitudinal end of the bellows to an opposing longitudinal end thereof.

Other embodiments comprise bellows pumps. In at least some embodiments, the bellows pump may comprise at least one fluid chamber, at least one fluid inlet port in communication with the at least one fluid chamber, at least one fluid outlet port in communication with the at least one fluid chamber, and at least one pressure chamber. The at least one pressure chamber may be at least partially defined by a bellows plunger comprising a substantially tubular body that includes a closed end at least partially in communication with the at least one fluid chamber and an opposing, open end. The substantially tubular body may further comprise a substantially continuous contour, extending as a helix from proximate the closed end to proximate the open end of the substantially tubular body.

In additional embodiments, the present invention includes methods of forming a helical bellows plunger. One or more embodiments of such methods may comprise filling a volume comprising a mold cavity with a molding material. The mold cavity may be formed between an outer surface of a mold core and an inner surface of a mold. The mold core may comprise an exterior surface having a substantially continuous, helically extending contour configured to form an internal surface of the helical bellows plunger. The mold may comprise an interior surface having a substantially continuous, helically extending contour of substantially the same pitch as that of the helically extending contour of the exterior surface of the mold core and adapted to align with the substantially continuous, helically extending contour of the exterior surface of the mold core. The interior surface of the mold may be configured to form an external surface of the helical bellows plunger. The molding material may be cured to form a helical bellows plunger, and the cured molding material may be removed from between the mold and the mold core.

### BRIEF DESCRIPTION OF THE DRAWINGS

FIG. 1 depicts an example of a reciprocating pump having two bellows plungers according to at least one embodiment of the present invention.

FIG. 2 is an isometric view of a bellows plunger having helically extending bellows according to at least one embodiment that may be suitable for use in the reciprocating pump depicted in FIG. 1.

FIG. 3 is an elevation view of the bellows plunger according to the embodiment of FIG. 2.

FIG. 4 is a cross-sectional view of the bellows plunger depicted in the embodiment of FIG. 2.

FIG. 5 depicts an assembled mold assembly for forming a bellows plunger according to at least one embodiment.

FIG. 6 depicts an exploded view of the mold assembly of FIG. 5, and a formed bellows plunger removed therefrom, the formed bellows plunger and mold core being in cross-sectional views.

### DETAILED DESCRIPTION

The illustrations presented herein are, in some instances, not actual views of any particular embodiments of reciprocating pumps or bellows plungers, but are merely idealized representations which are employed to describe the present invention. Additionally, elements common between figures may retain the same numerical designation.

Various embodiments of the present invention comprise fluid pumps which include at least one bellows plunger. In at least some embodiments, the bellows pump may include at least one fluid chamber including a fluid inlet port and a fluid outlet port in communication therewith. The bellows pump may further include a pressure chamber defined at least partially by a bellows plunger having a substantially continuous, helical contour extending from a position near one end thereof to a position near an opposing end thereof.

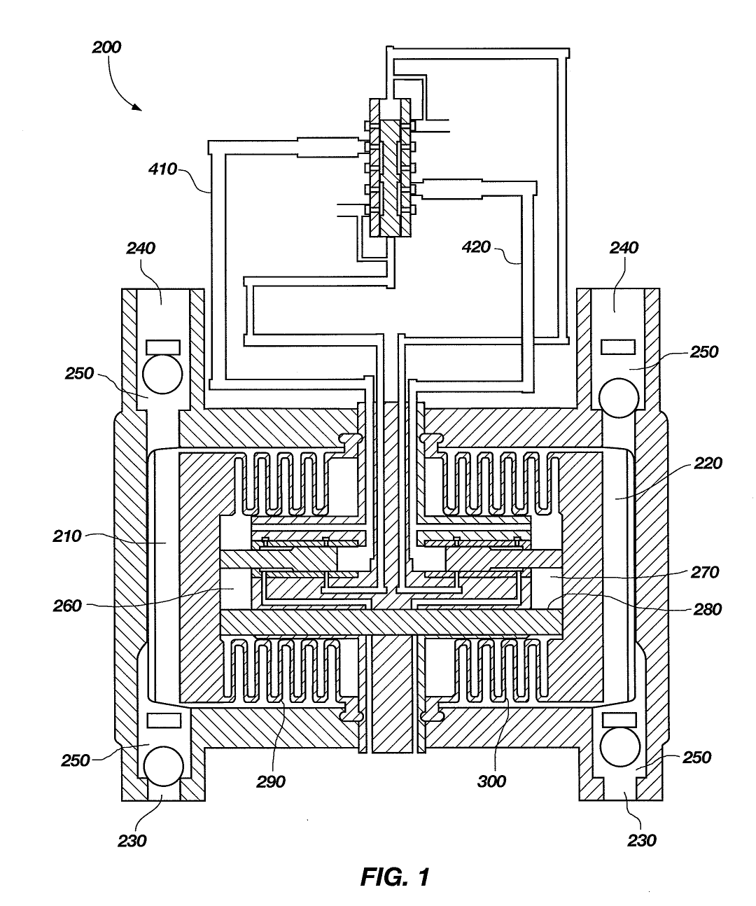

FIG. 1 illustrates an example of a bellows pump 200 having two fluid chambers and two pressure chambers defined by a bellows plunger according to a non-limiting embodiment of the present invention. The bellows pump 200 may include a first fluid chamber 210 and a second fluid chamber 220. First and second fluid chambers 210, 220 may be positioned opposite one another as illustrated and may be configured to receive a fluid therein.

The first and second fluid chambers 210, 220, respectively, may each be in communication with at least one fluid inlet port 230 and at least one fluid outlet port 240. The fluid inlet and outlet ports 230, 240 may be operable by one-way valves, also known as check valves 250. One suitable example of a check valve is a resiliently biased ball valve, which may prevent mixing of a fluid being drawn into the bellows pump 200 and the fluid being expelled from the bellows pump 200. Thus, the first and second fluid chambers 210, 220 may receive a volume of fluid through the fluid inlet port 230 and dispose a volume of fluid through the fluid outlet port 240.

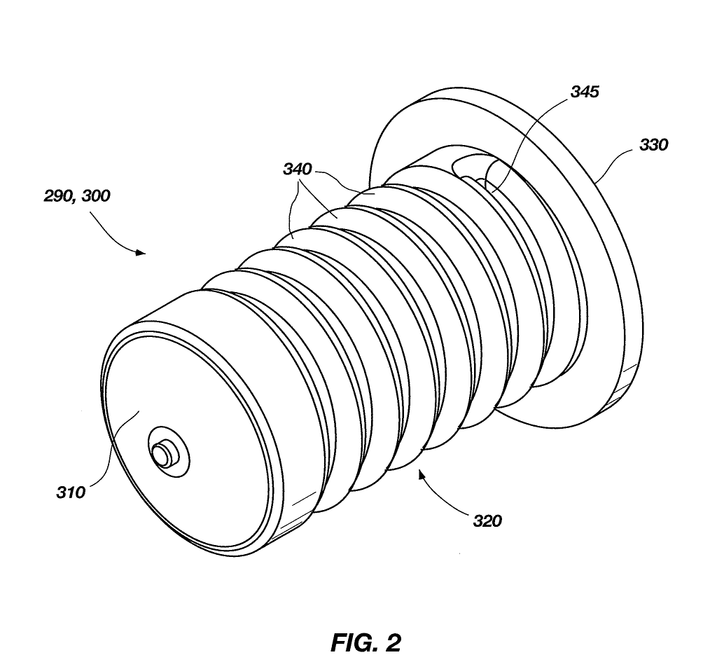

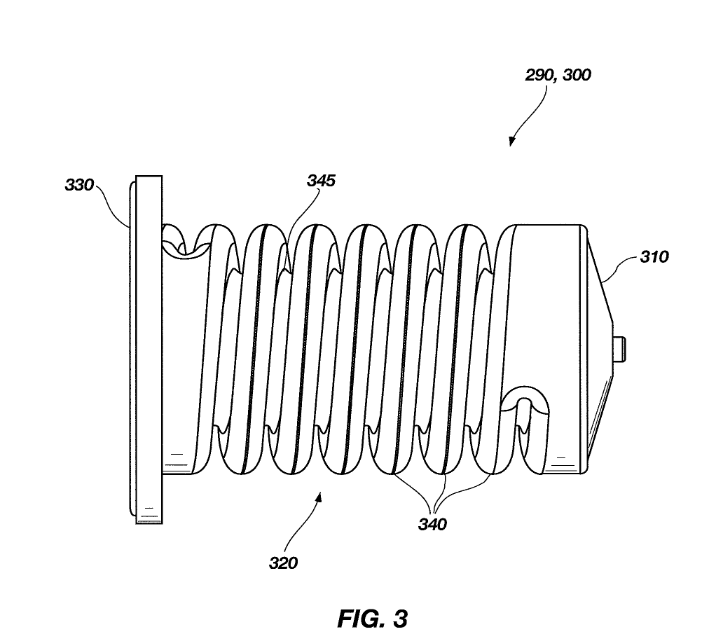

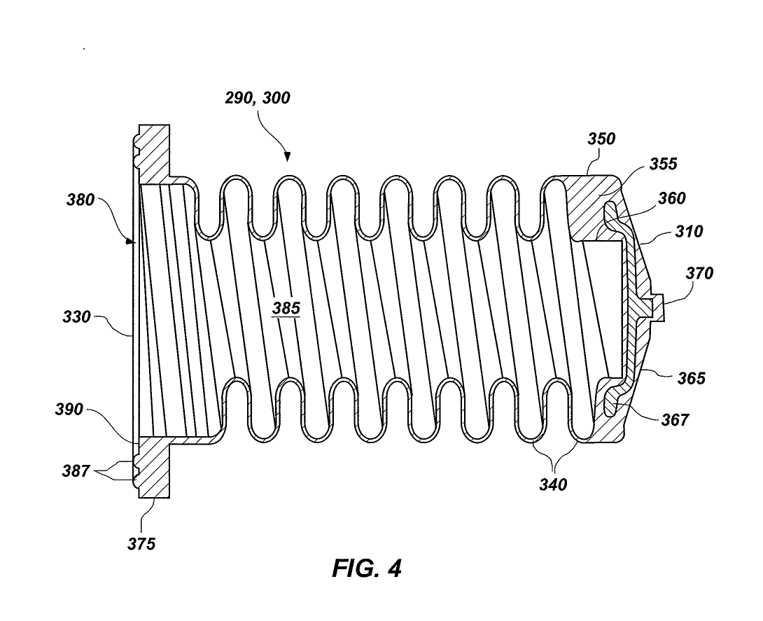

The volume of the first and second fluid chambers 210, 220, may be controlled by a first and a second pressure chamber 260, 270, respectively. The first and second pressure chambers 260, 270 may comprise a first bellows plunger 290 and a second bellows plunger 300, respectively. Referring to FIGS. 2-4 various views of a bellows plunger 290, 300 are illustrated according to at least one embodiment. The first and second bellows plunger 290, 300 may each comprise a closed end 310 at one end of a body 320 and an open end 330 at an opposing end thereof.

The body 320 of each bellows plunger 290, 300 may comprise a generally tubular body having at least substantially constant transverse cross-sectional dimensions along the length thereof. The cross-section may be of any shape suitable to fit within the first and second fluid chamber 210, 220 and the first and second pressure chamber 260, 270. The body 320 may include a substantially continuous, helical contour 340. The substantially continuous, helical contour 340 of the body 320, which acts as ribs of the bellows plunger 290, 300 comprises at least one continuous, helical groove 345 which extends from a position near the closed end 310 to a position near the open end 330. The helical contour 340 allows the body 320 of each bellows plunger 290, 300 to compress and expand longitudinally. The helical contour 340 may, thus, be appropriately characterized as “ribs” of the bellows plunger 290, 300, by enabling the body 320 to longitudinally expand and contract, even though the structure of the helical contour 340 provides a long, continuous rib rather than a plurality of discrete, laterally extending and longitudinally separated ribs of a conventional bellows plunger. Thus, expansion and contraction of the body 320 may be likened in operation to expansion and contraction of a coil spring.

The closed end 310 may comprise an end plate 355 coupled to the body 320. In some embodiments, the end plate 355 may be formed integral to the body 320, and in other embodiments, the closed end 310 may be formed separate from the body 320 and attached to the end of the body 320. For example, the closed end 310 may be attached with an adhesive, a fastener, heat sealing, or with some other known means, as well as combinations thereof. In at least some embodiments, the closed end 310 may comprise an annular flange 350 into which helical contour 340 extends. The end plate 355 may also include a recess 360 therein according to some embodiments. The exterior of closed end 310 may comprise a shaped surface 365 configured according to the specific application for the bellows plunger 290, 300. By way of example and not limitation, the shaped surface 365 may be at least substantially flat, frustoconical, convex or concave.

The shaped surface 365 may include a central protrusion 370 extending therefrom in some embodiments. In other embodiments, the shaped surface 365 may comprise an opening to permit attachment of some structure, such as a bolt or a shaft or other attachment structure. The opening may extend through the closed end 310 or partially into a portion of the closed end 310. The opening may comprise a through-hole in some embodiments, or a blind hole in other embodiments. Furthermore, the opening may be threaded in some embodiments to accommodate attachment of an attachment structure.

In some embodiments, the end plate 355 may comprise some structural insert 367 positioned therein. By way of example and not limitation, the end plate 355 may comprise a structure insert configured as a plate-like structure or reinforcement structure of some other configuration (e.g., ribs, mesh, etc.) formed at least partially within the end plate 355. The structural insert 367 may comprise a metal or metal alloy, such as steel, a plastic, or a ceramic material. Those of ordinary skill in the art will recognize that such materials are only exemplary and that various other materials, or combinations of materials, may be used for structural insert 367. The structural insert 367 may further include one or more features, such as attachment means for accommodating attachment of an attachment structure.

The open end 330 may comprise an annular flange 375 defining a central opening 380 to the interior 385 of bellows plunger 290, 300 and into which helical contour 340 extends. Annular flange 375 may be configured to accommodate securing the bellows plunger 290, 300 to some other structure or device. By way of example and not limitation, the annular flange 375 may comprise a rectangular cross section, taken longitudinally, configured to be clamped, or otherwise secured to some other structure or device. Furthermore, the annular flange 375 may comprise concentric ribs 387 on flat longitudinal end face 390 thereof according to at least some embodiments.

In some embodiments of the bellows pump 200, the closed end 310 of a bellows plunger 290, 300 may be positioned within a respective first or second fluid chamber 210, 220 for control of the volume of fluid therein. The closed end 310 of each bellows plunger 290, 300 may be positioned such that the closed ends 310 of each bellows plunger 290, 300 are facing away from each other. Such a configuration may be employed in a bellows pump 200 configured to comprise first and second fluid chambers 210, 220 positioned toward an outward portion of the bellows pump 200. However, such configuration is not intended to be limiting of the bellows pump 200 of the present invention. For example, in other embodiments, the first and second fluid chambers 210, 220 may be positioned toward an inward portion of the bellows pump 200, such as in the pump disclosed in U.S. patent application Ser. No. 11/437,447, the disclosure of which application is incorporated herein in its entirety by this reference. Additionally, although the bellows pump 200 is shown configured with the first and second pressure chambers 260, 270 located on the inside of the bellows plungers 290, 300 and the first and second fluid chambers 210, 220 located outside of the bellows plungers 290, 300 (FIG. 1), those of ordinary skill in the art will recognize that the pressure chambers and the fluid chambers may be transposed. For example, the first and second pressure chambers 260, 270 may be configured and located outside of the bellows plungers 290, 300 and the first and second fluid chambers 210, 220 may be configured and located inside of the bellows plungers 290, 300.

Furthermore, the positions of the closed end 310 of each of the bellows plungers 290, 300 may be fixed relative to one another with a shaft 280 (FIG. 1) coupled between the two closed ends 310. Although the shaft 280 is depicted in FIG. 1 as positioned near a lower portion of the bellows plungers 290, 300, such configuration is not intended to be limiting. Indeed, in most embodiments, the shaft 280 is positioned at least substantially centrally against the end plate 355 to reduce bending and torsional forces on the bellows plungers. The closed ends 310 also prevent fluid from passing from within the first and second fluid chambers 210, 220 to the respectively associated first and second pressure chambers 260, 270.

The open end 330 of each bellows plunger 290, 300 may be positioned away from the respective first and second fluid chamber 210, 220. The open end 330 of a bellows plunger 290, 300 may be placed in communication with an associated first and second control fluid input and exhaust line 410, 420 (FIG. 1). Although the lines 410, 420 are depicted as the same line for both control fluid input and exhaust, in other embodiments the control fluid input line may be distinct from the control fluid exhaust line.

The bellows pump 200 may be formed, by way of a non-limiting example, by forming at least one pump chamber and positioning a bellows plunger 290, 300 therein. The at least one pump chamber may be made up of the area comprising the first and second fluid chamber 210, 220 and the first and second pressure chamber 260, 270 with no bellows plunger 290, 300 therein. Positioning the bellows plunger 290, 300 may at least partially define a separation between the first and second fluid chamber 210, 220 and the first and second pressure chamber 260, 270. The bellows plunger 290, 300 may also comprise at least a portion of the first and second pressure chamber 260, 270, as described above.

In operation, a control fluid, for example, pressurized air, may flow from the first control fluid input and exhaust line 410 into the first pressure chamber 260 to cause expansion of the first pressure chamber 260 and, more particularly, expansion of the body 320 of the first bellows plunger 290. This expansion causes the closed end 310 of first bellows plunger 290 to move to the left, away from the second bellows plunger 300. Such a movement reduces the volume of the first fluid chamber 210 and forces the fluid through the check valve 250 and out the fluid outlet port 240 associated with the first fluid chamber 210. As the closed end 310 of the first bellows plunger 290 is forced leftward (with reference to the drawing figure, FIG. 1) by the expansion of the body 320, the closed end 310 of the second bellows plunger 300 may also be pulled leftward by a force exerted through shaft 280. Any control fluid within the second pressure chamber 270 may be expelled through the second control fluid input and exhaust line 420. The movement of the closed end 310 of the second bellows plunger 300 causes the volume of the second fluid chamber 220 to increase, and the volume of the second pressure chamber 270 to decrease. As the volume of the second fluid chamber 220 increases, fluid may be drawn into the second fluid chamber 220 through the fluid inlet port 230.

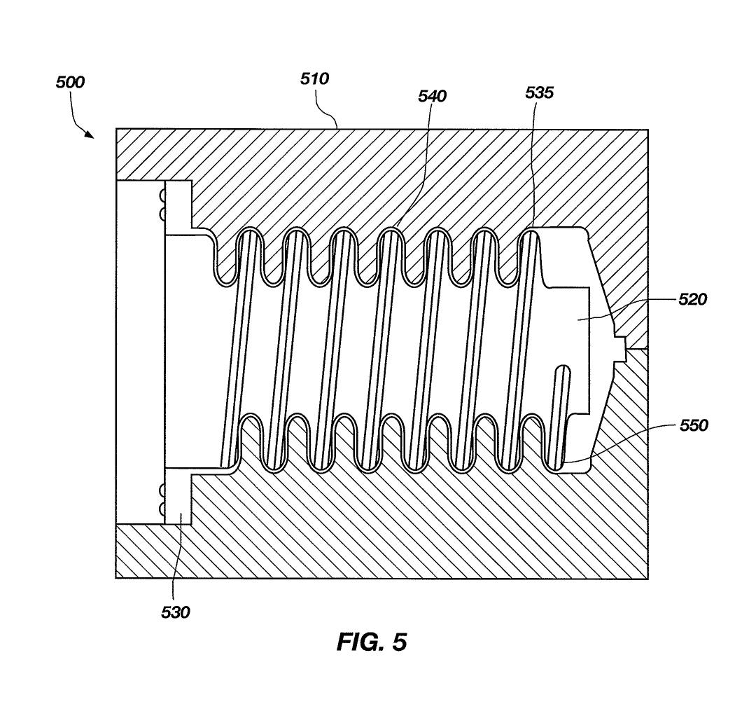

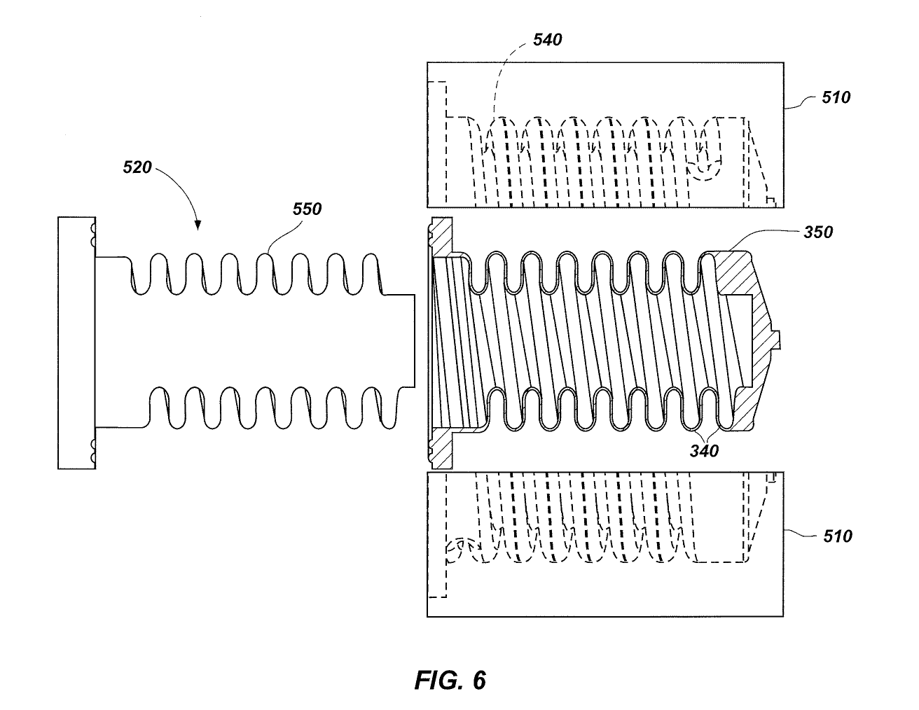

Additional embodiments of the invention include methods of making bellows plungers, such as bellows plungers 290, 300. The helical configuration of the contour 340 of the body 320 on the first and second bellows plungers 290, 300 may improve the ease with which a bellows plunger according to embodiments of the invention may be manufactured. FIGS. 5 and 6 illustrate a mold assembly 500 for forming a bellows plunger according to at least one embodiment. A mold 510 may be provided and positioned around at least a portion of a mold core 520. A volume 530 comprising a mold cavity between the mold 510 and the mold core 520 may then be filled with a molding material to form a bellows plunger.

In some embodiments, the mold 510 may comprise two half shells. In other embodiments, the mold 510 may comprise a greater number of elements mutually configured to be brought together to form the mold 510 having a laterally closed cavity. The mold 510 may include on an inner surface 535 thereof, a helically extending contour 540 for forming the external surface of the body 320 (FIG. 2), including the external surface of contour 340. The inner surface 535 of mold 510 may comprise consistent transverse cross-sectional dimensions along its length in order to form a bellows plunger having a consistent external transverse cross-sectional dimension of, for example, a substantially cylindrical shape.

The mold core 520 is provided and configured to form an internal surface of a bellows plunger, such as bellows plungers 290, 300. The internal surface of the bellows plunger 290, 300 is configured with a helically extending contour 550 extending along an exterior surface thereof. The helically extending contour 550 of mold core 520 is of substantially the same pitch as a pitch of the helically extending contour 540 of the inner surface 535 of mold 510 and is adapted, when mold core 520 is assembled with mold 510, to align with the helically extending contour 540 of mold 510 to form a continuous cavity therebetween into which molding material may be disposed, as by injection. Similar to the mold 510, the mold core 520 may comprise a consistent external transverse cross-sectional dimension along its length, in order to form a bellows plunger having consistent internal cross-sectional dimensions.

The mold core 520 may be positioned within the mold 510 with the helically extending contour 550 thereof aligned with the helically extending contour 540 of mold 510. The bellows plunger 300 may then be formed by filling the volume 530, comprising a mold cavity between the mold core 520 and the mold 510, with a suitable molding material. By way of example and not limitation, the molding material may be forced under pressure into the volume 530 between the mold core 520 and the mold 510 using conventional injection molding techniques. Suitable molding materials include, but are not limited to, polymeric materials such as moldable rubber compounds, thermoplastics, and fluoropolymeric compounds. By way of example and not limitation, the molding material may comprise neoprene, buna-N, ethylene diene M-class (EPDM), VITON®, polyurethane, HYTREL®, SANTOPRENE®, fluorinated ethylene-propylene (FEP), perfluoroalkoxy fluorocarbon resin (PFA), ethylene-chlorotrifluoroethylene copolymer (ECTFE), ethylene-tetrafluoroethylene copolymer (ETFE), nylon, polyethylene, polyvinylidene fluoride (PVDF), polyvinyl chloride (PVC), NORDEL™ and nitrile.

The molding material that fills the volume 530 may be cured in place in the mold assembly 500 to form a bellows plunger 290, 300. The newly formed bellows plunger 290, 300 may be extracted from the mold assembly 500 by removing the mold 510 from around the formed bellows plunger 290, 300 and removing the mold core 520 from within the bellows plunger 300. To remove the bellows plunger 300 from the mold 510, the mold 510 may be opened or disassembled from around the bellows plunger 290, 300. In other embodiments, the bellows plunger 300 may be removed by unscrewing the bellows plunger 300 from the mold 510.

The mold core 520 may be removed by unscrewing it from within the bellows plunger 290, 300 formed thereabout. Generally, the helically extending contour allows the bellows plunger 290, 300 to be easily removed by backing it off longitudinally from the mold core 520 by unscrewing it from about the mold core 520 or unscrewing the mold core 520 from within the formed bellows plunger 290, 300. Such an unscrewing process removes the problem of interference between the helical contour 340 in the bellows plunger 290, 300 and the helically extending contour 550 in the mold core 520, such as would be experienced during the fabrication of a conventional bellows with a plurality of transversely extending, discrete circumferential ribs. Thus, a suitably contoured, one piece mold core 520 may be employed in forming the internal features on the bellows plunger 300.

Although the described bellows pump is shown as employing two bellows, one of ordinary skill in the art will recognize that any pump employing a bellows is contemplated by this invention. By way of example and not limitation, the pump system may comprise any number of a plurality of bellows, as well as a single bellows, such as the pump disclosed in U.S. Pat. No. 5,165,866, the disclosure of which patent is incorporated herein in its entirety by this reference. Additionally, the pump system may be automatically operated, e.g., pneumatically or electrically, or may be manually operated. A non-limiting example of a manually operated pump system includes the system shown in U.S. Pat. No. 4,260,079, the disclosure of which patent is incorporated herein in its entirety by this reference. Indeed, one of ordinary skill in the art will recognize that various other pump systems that employ a bellows or variations of the pump systems described herein are, in various embodiments, encompassed by this invention. Furthermore, although the contour of the bellows plungers is illustrated as comprising only a single helical groove or single helical rib, one of ordinary skill in the art will recognize that two, or more, mutually parallel contours comprising grooves or ribs may be employed.

Thus, while certain embodiments have been described and shown in the accompanying drawings, such embodiments are merely illustrative and not restrictive of the scope of the invention, and this invention is not limited to the specific constructions and arrangements shown and described, since various other additions and modifications to, and deletions from, the described embodiments will be apparent to one of ordinary skill in the art. The scope of the invention, therefore, is only limited by the literal language, and legal equivalents, of the claims which follow.

1. A bellows plunger, comprising:
a tubular body;
an end plate coupled to the tubular body at one longitudinal end thereof;
an opening at an opposing longitudinal end; and
a substantially continuous, helical contour comprising at least one helical groove extending from proximate the end plate to proximate the opposing longitudinal end.

2. The bellows plunger of claim 1, wherein the tubular body further comprises a substantially constant transverse cross-sectional dimension along a length thereof.

3. The bellows plunger of claim 1, wherein the end plate is one of attached to the tubular body and formed integral to the tubular body.

4. The bellows plunger of claim 1, wherein the end plate comprises an annular flange into which a portion of the helical contour of the tubular body extends.

5. The bellows plunger of claim 1, wherein the end plate comprises a structural insert disposed at least partially therein.

6. The bellows plunger of claim 1, wherein the end plate comprises a shaped exterior surface which is one of frustoconical, flat, convex and concave.

7. The bellows plunger of claim 1, wherein the end plate comprises an opening extending at least partially into at least a portion thereof.

8. The bellows plunger of claim 1, wherein the opposing longitudinal end comprises an annular flange defining a central opening to an interior of the tubular body.

9. The bellows plunger of claim 1, wherein the tubular body is comprised of a material comprising one of a rubber compound, a thermoplastic, and a fluoropolymeric compound.

10. The bellows plunger of claim 9, wherein the material comprises a material selected from the list consisting of buna-N, ethylene diene M-class (EPDM), VITON®, polyurethane, HYTREL®, SANTOPRENE®, fluorinated ethylene-propylene (FEP), perfluoroalkoxy fluorocarbon resin (PFA), ethylene-chlorotrifluoroethylene copolymer (ECTFE), ethylene-tetrafluoroethylene copolymer (ETFE), nylon, polyethylene, polyvinylidene fluoride (PVDF), polyvinyl chloride (PVC), NORDEL™ and nitrile.

11. A bellows pump, comprising:
at least one fluid chamber;
at least one fluid inlet port in communication with the at least one fluid chamber;
at least one fluid outlet port in communication with the at least one fluid chamber; and
at least one pressure chamber at least partially defined by a bellows plunger, the bellows plunger comprising a tubular body including a closed end at least partially in communication with the at least one fluid chamber, an open end, and a plurality of contours extending as a helix from proximate the closed end to proximate the open end.

12. The bellows pump of claim 11, wherein the at least one fluid chamber comprises a plurality of fluid chambers and the at least one pressure chamber comprises a plurality of pressure chambers.

13. The bellows pump of claim 11, wherein the at least one fluid inlet port and the at least one fluid outlet port each comprise at least one one-way valve.

14. The bellows pump of claim 11, wherein the bellows plunger is comprised of a material comprising one of a rubber compound, a thermoplastic, and a fluoropolymeric compound.

15. The bellows pump of claim 14, wherein the material comprises a material selected from the list consisting of buna-N, ethylene diene M-class (EPDM), VITON®, polyurethane, HYTREL®, SANTOPRENE®, fluorinated ethylene-propylene (FEP), perfluoroalkoxy fluorocarbon resin (PFA), ethylene-chlorotrifluoroethylene copolymer (ECTFE), ethylene-tetrafluoroethylene copolymer (ETFE), nylon, polyethylene, polyvinylidene fluoride (PVDF), polyvinyl chloride (PVC), NORDEL™ and nitrile.

16. The bellows pump of claim 11, wherein the plurality of contours comprise at least one helical groove extending from proximate the closed end to proximate the open end.

17. The bellows pump of claim 11, wherein the closed end of the bellows plunger comprises an end plate coupled to the tubular body.

18. The bellows pump of claim 17, wherein the end plate is one of attached to the tubular body and formed integral to the tubular body.

19. The bellows pump of claim 17, wherein the end plate comprises a structural insert disposed at least partially therein.

20. The bellows pump of claim 17, wherein the end plate comprises an opening extending at least partially into at least a portion thereof.

21. A method of forming a helical bellows plunger, comprising:
filling a space between an outer surface of a mold core and an inner surface of a mold with a molding material, the mold core comprising a helically extending contour surface and the mold comprising a helically extending contour surface of substantially a same pitch and aligned with the helically extending contour of the mold to form a portion of a mold cavity therebetween;
curing the molding material to form a helical bellows plunger; and
separating the helical bellows plunger from the mold and the mold core.

22. The method of claim 21, wherein filling the space between an outer surface of the mold core and an inner surface of the mold with a molding material comprises filling the space between an outer surface of the mold core and an inner surface of the mold cavity with a mold material comprising one of a rubber compound, a thermoplastic, and a fluoropolymeric compound.

23. The method of claim 22, wherein filling the space between an outer surface of the mold core and an inner surface of the mold with a molding material comprises filling the space between an outer surface of the mold core and an inner surface of the mold cavity with a mold material selected from the list consisting of buna-N, ethylene diene M-class (EPDM), VITON®, polyurethane, HYTREL®, SANTOPRENE®, fluorinated ethylene-propylene (FEP), perfluoroalkoxy fluorocarbon resin (PFA), ethylene-chlorotrifluoroethylene copolymer (ECTFE), ethylene-tetrafluoroethylene copolymer (ETFE), nylon, polyethylene, polyvinylidene fluoride (PVDF), polyvinyl chloride (PVC), NORDEL™ and nitrile.

24. The method of claim 21, wherein filling the space between an outer surface of the mold core and an inner surface of the mold comprises injection molding.

25. The method of claim 21, wherein separating the helical bellows plunger from the mold core comprises unscrewing the helical bellows plunger from the mold core.
